(19) United States
(12) Patent Application Publication
(10) Pub. No.: US 2023/0281314 A1
(43) Pub. Date: Sep. 7, 2023

(54) MALWARE RISK SCORE DETERMINATION

(71) Applicant: SparkCognition, Inc., Austin, TX (US)

(72) Inventor: Jarred Capellman, Cedar Park, TX (US)

(21) Appl. No.: 17/653,322

(22) Filed: Mar. 3, 2022

(51) Int. Cl. G06F 21/57; H04L 9/40

(52) U.S. Cl. CPC G06F 21/577; H04L 63/20; G06F 2221/034; G06F 2221/033

(57) ABSTRACT

A device includes one or more processors configured to collect, at a client device, device data associated with the client device. The one or more processors are configured to determine, at the client device, a risk score associated with the client device based on the device data. The risk score indicates a likelihood that the client device is vulnerable to a malware attack. The one or more processors are also configured to send the risk score from the client device to a management server. Security protocols are implemented at the client device in response to a command from the management server. The command is based at least in part on the risk score.

### FIELD

The present disclosure is generally related to determining a likelihood that a client device is vulnerable to a malware attack.

### BACKGROUND

Different processes performed at a client device can make the client device vulnerable to a malware attack. As a non-limiting example, installing questionable software at the client device can make the client device vulnerable to a malware attack. As another non-limiting example, if the client device accesses an internet protocol (IP) address that is historically associated with malware, there is an increased likelihood that the client device will become more vulnerable to a malware attack. If malware is detected at the client device, remedial actions are taken. However, remedial actions may be time consuming and costly.

In some client monitoring systems, a client device sends an expansive amount of client device data to a management server. The client device data can describe operations and processes performed at the client device. Based on the client device data, the management server can determine whether the client device is at risk or whether the client device has been infected with malware. However, processing efficiency at the management server can be sacrificed as a result of filtering through the relatively expansive amount of client device data to identify data indicative of malware.

### SUMMARY

In some aspects, a device includes one or more processors configured to collect, at a client device, device data associated with the client device. The one or more processors are configured to determine, at the client device, a risk score associated with the client device based on the device data. The risk score indicates a likelihood that the client device is vulnerable to a malware attack. The one or more processors are also configured to send the risk score from the client device to a management server. Security protocols are implemented at the client device in response to a command from the management server. The command is based at least in part on the risk score.

In some aspects, a method includes collecting, at a client device, device data associated with the client device. The method also includes determining, at the client device, a risk score associated with the client device based on the device data. The risk score indicates a likelihood that the client device is vulnerable to a malware attack. The method further includes sending the risk score from the client device to a management server. Security protocols are implemented at the client device in response to a command from the management server. The command is based at least in part on the risk score.

In some aspects, a non-transitory computer-readable medium stores instructions that are executed by one or more processors. The instructions, when executed by the one or more processors, cause the one or more processors to collect, at a client device, device data associated with the client device. The instructions, when executed by the one or more processors, further cause the one or more processors to determine, at the client device, a risk score associated with the client device based on the device data. The risk score indicates a likelihood that the client device is vulnerable to a malware attack. The instructions, when executed by the one or more processors, also cause the one or more processors to send the risk score from the client device to a management server. Security protocols are implemented at the client device in response to a command from the management server. The command is based at least in part on the risk score

### BRIEF DESCRIPTION OF THE DRAWINGS

FIG. 1 illustrates a block diagram of a system configured to determine a risk score that indicates a likelihood that a client device is vulnerable to a malware attack, in accordance with some examples of the present disclosure.

FIG. 2 illustrates a diagram of a system operable to generate output data indicative of the risk score, in accordance with some examples of the present disclosure.

FIG. 3 illustrates a diagram of a system operable to determine the risk score based on different output data, in accordance with some examples of the present disclosure.

FIG. 4 is a flow chart of an example of a method for determining a risk score that indicates a likelihood that a client device is vulnerable to a malware attack.

### DETAILED DESCRIPTION

Systems and methods are described that enable a client device to determine a likelihood that the client device is vulnerable to a malware attack and send data (e.g., a risk score) to a management server to implement security protocols based on the likelihood. To illustrate, a processor at the client device can collect device data associated with the client device. The device data can include different types of software installed at the client device, different versions of software installed at the client device, software developer information, internet protocol (IP) addresses accessed at the client device, implemented security settings at the client device, one or more processes executed at the client device, etc. Based on an analysis of the device data, the processor can compute a risk score that indicates the likelihood that the client device is vulnerable to a malware attack.

To illustrate, in some scenarios, the processor can determine that a particular type of software installed at the client device has a known vulnerability. In these scenarios, the processor can increase the risk score in response to a determination that the particular type of software is installed at the client device. In other scenarios, the processor can determine whether the client device has accessed IP addresses that are historically associated with malware. In these scenarios, the processor can increase the risk score in response to a determination that the client device has accessed IP addresses historically associated with malware and can decrease the risk score in response to a determination that the client device has not accessed IP addresses historically associated with malware.

The client device can send the risk score, and corresponding information used to determine the risk score, to a management server. Based on the risk score, the management server can determine whether to initiate security protocols to protect the client device or other devices connected to the client device. As a non-limiting example, if the risk score exceeds a risk score threshold, the management device can send a command to isolate the client device from a shared network. As another non-limiting example, if the risk score exceeds the risk score threshold, the management device can send a command to change (e.g., heighten) security settings at the client device.

By determining the risk score at the client device and sending the risk score (and the corresponding information used to determine the risk score) to the management server, a reduced amount of data is monitored and analyzed at the management server. For example, as opposed to receiving all of the device data collected at the client device, the management server can receive the risk score that is based on the device data and determine security protocols based on the risk score. As a result, the processing efficiency at the management server can be improved.

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, spatial attention layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that the during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

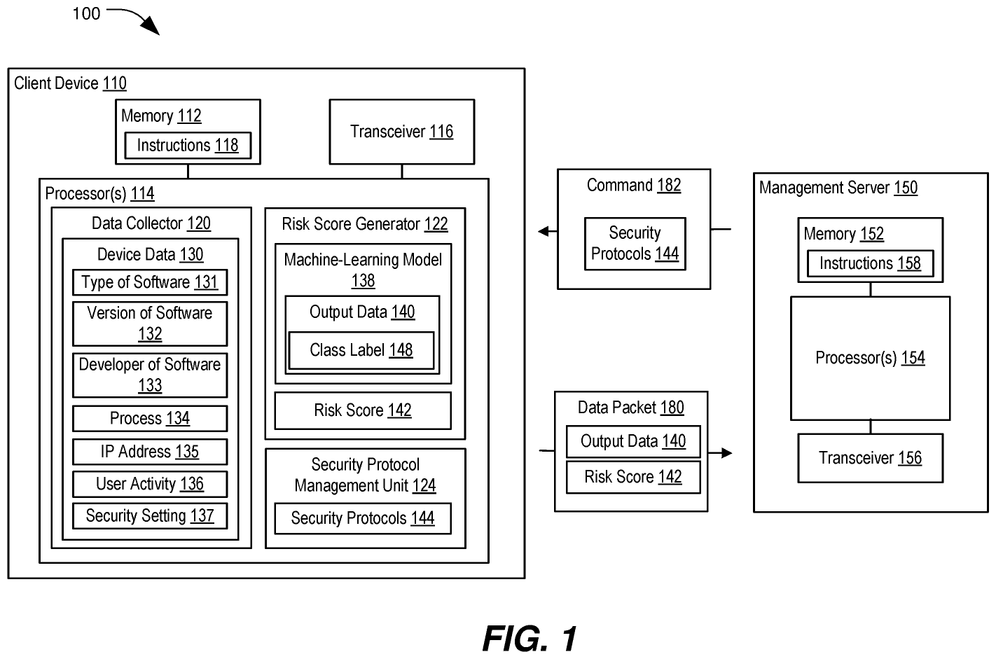

Referring to FIG. 1, a system operable to determine a risk score that indicates a likelihood that a client device is vulnerable to a malware attack is shown and generally designated 100. The system 100 includes a client device 110 and a management server 150. The client device 110 is configured to send one or more data packets 180 to the management server 150. As described below, the one or more data packets 180 can include a risk score 142 that indicates a likelihood that client device 110 is vulnerable to a malware attack. Based on the risk score 142, the management server 150 can identify security protocols 144 to be implemented at the client device 110.

The client device 110 can correspond to any electronic device that communicates over a network or any electronic device that is subjectable to a malware attack. According to some implementations, the client device 110 can fall within different classifications. As non-limiting examples, the classification of the client device 110 can correspond to at least one of a governmental agency device, a military department device, a banking system device, a school system device, a business device, or a personal device. As described below, the security protocols 144 implemented at the client device 110 can be based at least in part on the classification of the client device 110. For example, relatively strict security protocols 144 can be implemented if the client device 110 is a governmental agency device, and relatively relaxed security protocols 144 can be implemented if the client device 110 is a personal device.

The client device 110 includes a memory 112, one or more processors 114 coupled to the memory 112, and a transceiver 116 coupled to the one or more processors 114. The memory 112 can be a non-transitory computer-readable medium (e.g., a storage device) that includes instructions 118 that are executable by the one or more processors 114 to perform the operations described herein. Although FIG. 1 depicts a transceiver 116, in other implementations, the client device 110 can include a receiver and a transmitter. It should be understood that the client device 110 illustrated in FIG. 1 can include additional components and that the components illustrated in FIG. 1 are merely for ease of description.

The one or more processors 114 includes a data collector 120, a risk score generator 122, and a security protocol management unit 124. According to one implementation, one or more of the components of the one or more processors 114 can be implemented using dedicated hardware, such as an application-specific integrated circuit (ASIC) or a field programmable gate array (FPGA). According to other implementations, one or more of the components of the one or more processors 114 can be implemented by executing the instructions 118 stored in the memory 112.

The data collector 120 is configured to collect device data 130 associated with the client device 110. The device data 130 can indicate at least one of a type of software 131 installed at the client device 110, a version of software 132 installed at the client device 110, a developer of software 133 installed at the client device 110, a process 134 executed at the client device 110, an internet protocol (IP) address 135 accessed at the client device 110, user activity 136 at the client device 110, a security setting 137 implemented at the client device 110, or other types of data associated with the client device 110. The data collector 120 can poll different components of the client device 110 (e.g., storage devices, data logs, processing logs, etc.) to collect the device data 130.

The risk score generator 122 is configured to determine the risk score 142 associated with the client device 110 based on the device data 130. The risk score 142 indicates a likelihood that the client device 110 is vulnerable to a malware attack. To determine the risk score 142, the risk score generator 122 is configured to provide the device data 130 as an input to a machine-learning model 138. The machine-learning model 138 is configured to generate output data 140 based on the device data 130. The output data 140 indicates a class label 148 for one or more attributes of the device data 130. The risk score 142 can be generated based on the output data 140. According to some implementations, the risk score 142 can be dynamically updated instead of a one-time computation. For example, the risk score 142 can be periodically updated (e.g., recomputed) or can be updated based on certain types of events, such as a new network connection, installation of new software, etc.

To generate the output data 140, the machine-learning model 138 can be compiled in a library and can access feature data (e.g., feature vectors) on the client device 110 (e.g., the endpoint) identify and process real-time activity on the client device 110, such as software updates, application updates, processes, registry writes, network connections, etc. According to one implementation, the feature data can have a JavaScript Object Notation (JSON) format that identifies actions, sensor specific features, timestamps, etc. As described in greater detail below, by identifying and processing real-time activity on the client device 110, the machine-learning model 138 can identify outdated versions of applications installed at the client device 110. Furthermore, the machine-learning model 138 can determine a likelihood that the client device 110 is vulnerable to a malware attack based on the outdated versions. According to some implementations, the machine-learning model 138 is an autoregressive model that generates outputs based on a rolling window of data accessible via the database. The machine-learning model 138 can use a binary classification algorithm, a gradient boosting framework that utilizes tree-based learning algorithms, etc. According to some implementations, the machine-learning model 138 can be selected based on an operating system, or a version of an operating system, that is running on the client device 110. According to some implementations, the particular machine-learning model 138 can be based on a computer configuration.

According to one implementation, the machine-learning model 138 can be configured to determine whether a particular type of software 131 installed at the client device 110 has a known vulnerability. As a non-limiting example, the machine-learning model 138 can determine that photo-editing software has known vulnerabilities that subject electronic devices to malware attacks. In response to the device data 130 indicating that photo-editing software is installed at the client device 110, the machine-learning model 138 can determine that a known vulnerability is present in the photo-editing software. The machine-learning model 138 is configured to generate a particular portion of the output data 140 indicating whether the particular type of software 131 has a known vulnerability. The risk score generator 122 can increase the risk score 142 in response to the particular portion of the output data 140 having a first value indicating the particular type of software 131 has a known vulnerability. Alternatively, the risk score generator 122 can decrease the risk score 142 in response to the particular portion of the output data 140 having a second value indicating the particular type of software 131 does not have a known vulnerability.

The machine-learning model 138 can also be configured to determine whether a version of software 132 installed at the client device 110 is a latest version of the software. As a non-limiting example, the machine-learning model 138 can assign lighter weights to updated versions of software and heavier weights to outdated versions of software. The weights can indicate, at least in part, a likelihood that software is vulnerable to malware attacks. Thus, updated versions of software are less likely to be subject to a malware attack and are assigned lighter weights, while outdated versions of software are more likely to be subject to a malware attack and are assigned heavier weights. For example, a third edition of a particular word-processing software is more likely to be subject to a malware attack than a fifth edition of the particular word-processing software. The machine-learning model 138 is configured to generate a particular portion of the output data 140 indicating whether the version of the software 132 is the latest version of the software. The risk score generator 122 can increase the risk score 142 in response to the particular portion of the output data 140 having a first value indicating the version of software 132 is not the latest version of the software. Alternatively, the risk score generator 122 can decrease the risk score 142 in response to the particular portion of the output data 140 having a second value indicating the version of software 132 is the latest version of the software.

The machine-learning model 138 can also be configured to determine whether a developer of particular software 133 installed at the client device 110 has developed other software with known vulnerabilities. As a non-limiting example, if Company ABC has developed software with known vulnerabilities over a particular time period (e.g., within the past three years), the machine-learning model 138 can assign different weights to software developed by Company ABC to indicate a likelihood that the software is vulnerable to a malware attack. The machine-learning model 138 is configured to generate a particular portion of the output data 140 indicating whether the developer of the particular software 133 has developed other software with known vulnerabilities. The risk score generator 122 can increase the risk score 142 in response to the particular portion of the output data 140 having a first value indicating the developer of the particular software 133 has developed other software with known vulnerabilities. Alternatively, the risk score generator 122 can decrease the risk score 142 in response to the particular portion of the output data 140 having a second value indicating the developer of the particular software 133 has not developed other software with known vulnerabilities.

The machine-learning model 138 can also be configured to determine whether a particular process 134 executed at the client device 110 has a known vulnerability. As a non-limiting example, if an operating system of the client device 110 injects and executes a particular command during runtime that is independent of a user instruction, the machine-learning model 138 can determine whether the particular command has a known vulnerability. The machine-learning model 138 is configured to generate a particular portion of the output data 140 indicating whether the particular process 134 has a known vulnerability. The risk score generator 122 can increase the risk score 142 in response to the particular portion of the output data 140 having a first value indicating the particular process 134 has a known vulnerability. Alternatively, the risk score generator 122 can decrease the risk score 142 in response to the particular portion of the output data 140 having a second value indicating the particular process 134 does not have a known vulnerability.

The machine-learning model 138 can also be configured to determine whether an IP address 135 accessed at the client device 110 is historically associated with malware. The machine-learning model 138 is configured to generate a particular portion of the output data indicating whether the IP address 135 is historically associated with malware. The risk score generator 122 can increase the risk score 142 in response to the particular portion of the output data 140 having a first value indicating the IP address 135 is historically associated with malware. Alternatively, the risk score generator 122 can decrease the risk score 142 in response to the particular portion of the output data 140 having a second value indicating the IP address 135 is not historically associated with malware.

The machine-learning model 138 can also be configured to determine whether a security setting 137 implemented at the client device 110 is a recommended security setting. As a non-limiting example, different security settings can be implemented at the client device 110 to protect against malware. To illustrate, if a low security setting is implemented at the client device 110, the client device 110 can be relatively vulnerable to a malware attack. However, if a high security setting (e.g., a recommended security setting) is implemented at the client device 110, the client device 110 is less vulnerable to a malware attack. The machine-learning model 138 is configured to generate a particular portion of the output data 140 indicating whether the security setting 137 is the recommended security setting. According to one implementation, the machine-learning model 138 can determine the recommended security setting based on a historically implemented security setting and a corresponding success rate for preventing malware attacks. For example, if a particular security setting has been implemented for a particular period of time and the client device 110 has successfully prevented malware attacks during the particular period of time, the machine-learning model 138 can determine that the particular security setting is the recommended security setting. The risk score generator 122 can increase the risk score 142 in response to the particular portion of the output data 140 having a first value indicating the security setting 137 is not the recommended security setting. Alternatively, the risk score generator 122 can decrease the risk score 142 in response to the particular portion of the output data 140 having a second value indicating the security setting 137 is the recommended security setting.

The one or more processors 114 are configured to initiate transmission of the risk score 142 from the client device 110 to the management server 150. For example, the one or more processors 114 can insert the data indicative of the risk score 142 into a data packet 180, and the transceiver 116 can transmit the data packet 180 to the management server 150. According to some implementations, as illustrated in FIG. 1, the one or more processors 114 can insert the output data 140 into the data packet 180 such that the management server 150 receives the risk score 142 and the output data 140.

In some scenarios, the output data 140 that is transmitted to the management server 150 can include a subset of the output device data 130 collected by the data collector 120. For example, if the risk score 142 is substantially high due to process logs associated with the process 134, the output data 140 transmitted to the management server 150 can include the process logs. In this scenario, data that does not substantially contribute to the high risk score 142 can be excluded from the output data 140 that is transmitted to the management server 150. As a result, the management server 150 can determine the security protocols 144 without having to process an excess amount of data.

The management server 150 includes one or more processors 154, a memory 152 coupled to the one or more processors 154, and a transceiver 156 coupled to the one or more processors 154. The memory 152 can be a non-transitory computer-readable medium (e.g., a storage device) that includes instructions 158 that are executable by the one or more processors 154 to perform the operations described herein. Although FIG. 1 depicts a transceiver 156, in other implementations, the management server 150 can include a receiver and a transmitter. It should be understood that the management server 150 illustrated in FIG. 1 can include additional components and that the components illustrated in FIG. 1 are merely for ease of description.

The transceiver 156 is configured to receive the data packet 180 from the client device 110. Based on the risk score 142, the output data 140, or both, the one or more processors 154 are configured to identify security protocols 144 to be implemented at the client device 110. For example, the one or more processors 154 can determine how vulnerable the client device 110 is to a malware attack based on the risk score 142 and can implement security measures based on the level of vulnerability. According to some implementations, the security protocols 144 to be implemented at the client device 110 include the security setting 137. For example, the security protocols 144 can include changing the security setting 137 from the low security setting to the high (e.g., recommended) security setting. According to other implementations, the security protocols 144 to be implemented at the client device 110 include isolating the client device 110 from a shared network. For example, if the client device 110 is connected to a similar network as other devices, the management server 150 can instruct the client device 110 to leave the network as to not subject the other devices to potential malware attacks.

The one or more processors 154 are configured to generate a command 182 that identifies the security protocols 144 to be implemented at the client device 110, and the transceiver 156 is configured to send the command 182 to the client device 110. In response to receiving the command 182, the security protocol management unit 124 can implement the security protocols 144 at the client device 110.

In some scenarios, the command 182 is based on a classification of the client device 110. As described above, the classification of the client device 110 can correspond to at least one of a governmental agency device, a military department device, a banking system device, a school system device, a business device, a personal device, etc. In the scenario where the client device 110 is a military department device, the security protocols 144 identified in the command 182 can instruct the client device 110 to isolate from shared networks, as a malware attack on a military department device may compromise national security and should be treated in a serious manner. However, in the scenario where the client device 110 is a personal device, the security protocols 144 identified in the command 182 can instruct the client device 110 to change the security setting 137 to a recommended security setting.

The system 100 of FIG. 1 improves processing efficiency at the management server 150 by reducing the amount of data the management server 150 has to filter through to determine whether the client device 110 is at risk for malware. To illustrate, instead of sending an expansive amount of data (e.g., the device data 130) to the management server 150, the client device 110 can perform a client-side determination of the risk score 142 and send data indicative of the risk score 142 (e.g., the output data 140 and the risk score 142) to the management server 150. For example, the output data 140 that is transmitted to the management server 150 is smaller than (e.g., is a subset of) the device data 130 and includes features of the device data 130 that have a substantial influence on the risk score 142. To illustrate, if the risk score 142 is high because of a visited IP address 135, the output data 140 can include IP logs (as opposed to logs associated with processes 134). As a result, the management server 150 receives a relatively small amount of data to process and can determine the appropriate security protocols 144 based on the small amount of data. Thus, the techniques described with respect to FIG. 1 enable the client device 110 to monitor parameters (e.g., open network connections, ports, etc.) for a process 134, accessed IP addresses 135, data written to a registry, installed software, installed applications, system settings, and other client-side activity to determine the likelihood (e.g., the risk score 142) that the client device 110 is vulnerable to a malware attack. Based on the likelihood, the client device 110 can send indicative data to the management server 150 to recommend security protocols 144.

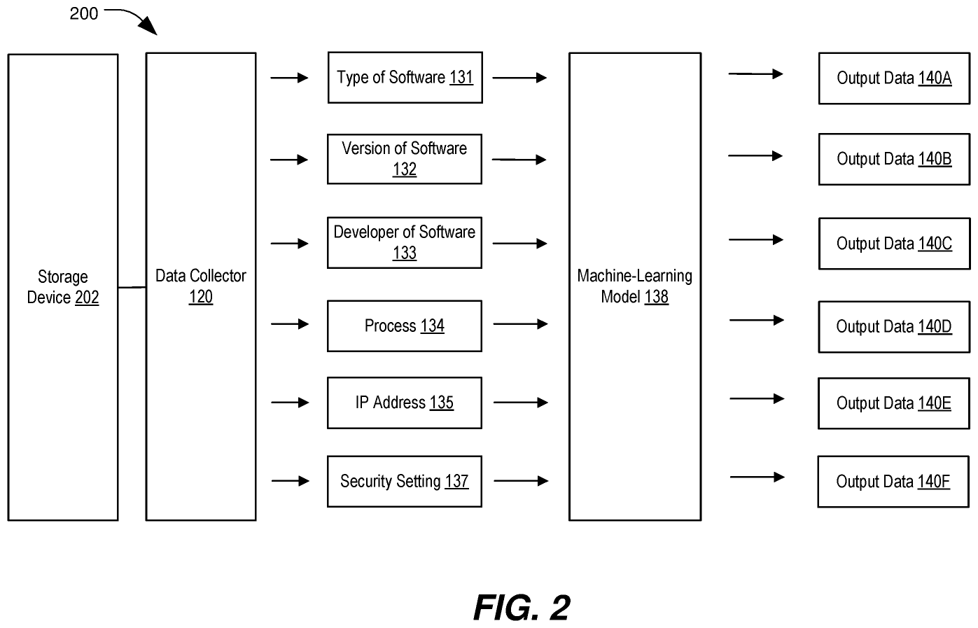

Referring to FIG. 2, a system operable to generate output data indicative of the risk score is shown and generally designated 200. The system 200 includes a storage device 202, the data collector 120, and the machine-learning model 138. The components of the system 200 can be integrated into the client device 110 of FIG. 1. According to some implementations, the storage device 202 can correspond to the memory 112 of FIG. 1. According to other implementations, the storage device 202 can correspond to another memory or data cache integrated into the client device 110.

The data collector 120 is configured to fetch data stored at the storage device 202 to identify the device data 130. For example, the data collector 120 can fetch data that indicates the type of software 131 installed at the client device 110, the version of software 132 installed at the client device 110, the developer of software 133 installed at the client device 110. Additionally, or in the alternative, the data collector 120 can monitor activity at the client device 110 to determine the process 134 executed at the client device 110, IP address 135 accessed at the client device 110, user activity 136 at the client device 110, the security setting 137 implemented at the client device 110, or other types of data associated with the client device 110.

As illustrated in FIG. 2, the data collector 120 is configured to provide data indicative of the particular type of software 131 installed at the client device 110 to the machine-learning model 138. The machine-learning model 138 can be configured (e.g., trained) to determine whether the particular type of software 131 installed at the client device 110 has a known vulnerability. For example, the machine-learning model 138 can use historical data associated with the particular type of software to determine whether the particular type of software 131 has a known vulnerability. To illustrate, historical data can indicate that photo-editing software has been vulnerable to malware attacks. The machine-learning model 138 can use this this historical data to determine whether a particular photo-editing software has a known vulnerability. Based on the determination, the machine-learning model 138 is configured to generate a particular portion of the output data 140A indicating whether the particular type of software 131 has a known vulnerability.

As illustrated in FIG. 2, the data collector 120 is also configured to provide data indicative of the version of software 132 installed at the client device 110 to the machine-learning model 138. The machine-learning model 138 can also be configured (e.g., trained) to determine whether the version of software 132 installed at the client device 110 is a latest version of the software. Based on the determination, the machine-learning model 138 is configured to generate a particular portion of the output data 140B indicating whether the version of the software 132 is the latest version of the software.

As illustrated in FIG. 2, the data collector 120 is also configured to provide data indicative of the developer of the particular software 133 installed at the client device 110 to the machine-learning model 138. The machine-learning model 138 can also be configured (e.g., trained) to determine whether the developer of the particular software 133 installed at the client device 110 has developed other software with known vulnerabilities. Based on the determination, the machine-learning model 138 is configured to generate a particular portion of the output data 140C indicating whether the developer of the particular software 133 has developed other software with known vulnerabilities.

As illustrated in FIG. 2, the data collector 120 is also configured to provide data indicative of the particular process 134 executed at the client device 110 to the machine-learning model 138. The machine-learning model 138 can also be configured (e.g., trained) to determine whether the particular process 134 executed at the client device 110 has a known vulnerability. Based on the determination, the machine-learning model 138 is configured to generate a particular portion of the output data 140D indicating whether the particular process 134 has a known vulnerability.

As illustrated in FIG. 2, the data collector 120 is also configured to provide data indicative of the IP address 135 accessed at the client device 110 to the machine-learning model 138. The machine-learning model 138 can also be configured (e.g., trained) to determine whether an IP address 135 accessed at the client device 110 is historically associated with malware. Based on the determination, the machine-learning model 138 is configured to generate a particular portion of the output data 140E indicating whether the IP address 135 is historically associated with malware.

As illustrated in FIG. 2, the data collector 120 is also configured to provide data indicative of the selected security setting 137 at the client device 110 to the machine-learning model 138. The machine-learning model 138 can also be configured (e.g., trained) to determine whether the security setting 137 implemented at the client device 110 is the recommended security setting. Based on the determination, the machine-learning model 138 is configured to generate a particular portion of the output data 140F indicating whether the security setting 137 is the recommended security setting.

The system 200 of FIG. 2 improves processing efficiency at a remote server (e.g., the management server 150) by reducing the amount of data the remote server has to filter through to determine whether the client device 110 is at risk for malware. For example, instead of filtering through an expansive amount of data 131-137 at the remote server, the system 200 at the client device 110 can perform a client-side determination of factors indicating the likelihood that the client device 110 is vulnerable to a malware attack. Thus, the remote server receives a relatively small amount of data (e.g., the output data 140A-140F) to process and can determine the appropriate security protocols 144 based on the small amount of data.

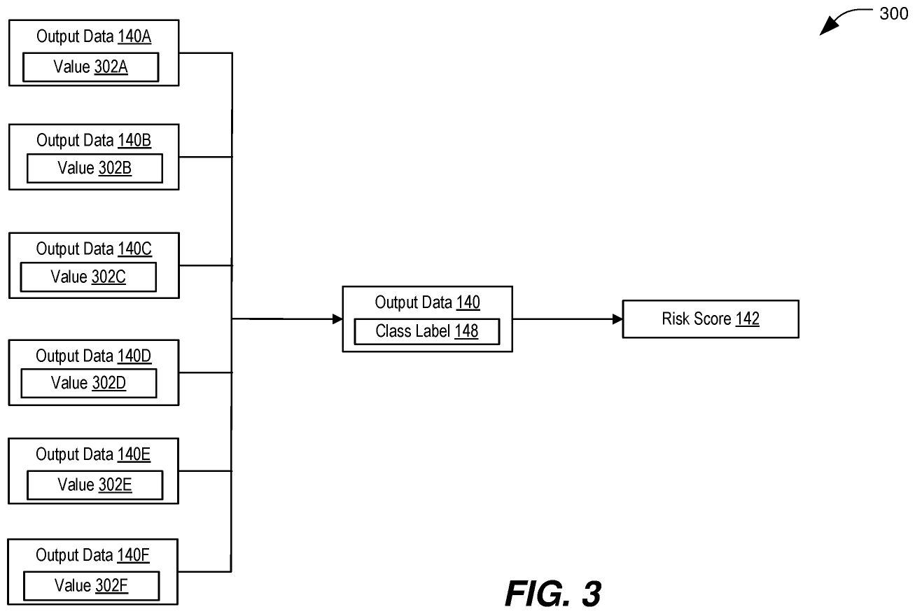

Referring to FIG. 3, a system operable to determine the risk score based on different output data is shown and generally designated 300. Operations of the system 300 can be performed using the risk score generator 122.

In FIG. 3, each portion of the output data 140A-140E has a corresponding value 302A-302E. According to a scenario described with respect to FIG. 2, the value 302A of the output data 140A indicates whether the particular type of software 131 has a known vulnerability. For example, if the value 302A corresponds to a first value (e.g., a logical “1” value), the output data 140A can indicate that the particular type of software 131 has a known vulnerability. However, if the value 302A corresponds to a second value (e.g., a logical “0” value), the output data 140A can indicate that the particular type of software 131 does not have a known vulnerability. According to some implementations, the value 302A can be an integer, a floating-point value, or another data value that indicates a probability that the particular type of software has a vulnerability.

The value 302B of the output data 140B indicates whether the version of the software 132 installed at the client device 110 is the latest version. For example, if the value 302B corresponds to a first value (e.g., a logical “1” value), the output data 140B can indicate that the version of the software 132 is not the latest version. However, if the value 302B corresponds to a second value (e.g., a logical “0” value), the output data 140B can indicate that the version of the software 132 is the latest version. According to some implementations, the value 302B can be an integer, a floating-point value, or another data value that indicates a probability that the version of the software 132 is the latest version. This probability can be based on a rate at which a developer of the software 132 has historically released new versions.

The value 302C of the output data 140C indicates whether the developer of the particular software 133 installed at the client device 110 has developed other software with known vulnerabilities. For example, if the value 302C corresponds to a first value (e.g., a logical “1” value), the output data 140C can indicate that the developer of the particular software 133 has developed other software with known vulnerabilities. However, if the value 302C corresponds to a second value (e.g., a logical “0” value), the output data 140C can indicate that the developer of the particular software 133 has not developed other software with known vulnerabilities. According to some implementations, the value 302C can be an integer, a floating-point value, or another data value that indicates a probability that the developer generated software with a vulnerability. For example, the probability can be based on historical data indicating a percentage of software (from the developer) that has vulnerabilities.

The value 302D of the output data 140D indicates whether the particular process 134 executed at the client device 110 has a known vulnerability. For example, if the value 302D corresponds to a first value (e.g., a logical “1” value), the output data 140D can indicate that the particular process 134 executed at the client device 110 has a known vulnerability. However, if the value 302D corresponds to a second value (e.g., a logical “0” value), the output data 140D can indicate that the particular process 134 executed at the client device 110 does not have a known vulnerability. According to some implementations, the value 302D can be an integer, a floating-point value, or another data value that indicates a probability that the particular process 134 executed at the client device 110 has a vulnerability.

The value 302E of the output data 140E indicates whether the IP address 135 accessed at the client device 110 is historically associated with malware. For example, if the value 302E corresponds to a first value (e.g., a logical “1” value), the output data 140E can indicate that the IP address 135 accessed at the client device 110 is historically associated with malware. However, if the value 302E corresponds to a second value (e.g., a logical “0” value), the output data 140E can indicate that the IP address 135 accessed at the client device 110 is not historically associated with malware. According to some implementations, the value 302E can be an integer, a floating-point value, or another data value that indicates a probability that the IP address is associated with malware.

The value 302F of the output data 140F indicates whether the security setting 137 implemented at the client device 110 is the recommended security setting. For example, if the value 302F corresponds to a first value (e.g., a logical “1” value), the output data 140E can indicate that the security setting 137 implemented at the client device 110 is not the recommended security setting. However, if the value 302F corresponds to a second value (e.g., a logical “0” value), the output data 140F can indicate that the security setting 137 implemented at the client device 110 is the recommended security setting.

The values 302A-302F of the output data 140A-140F can be processed (e.g., combined, inserted into an ML algorithm, etc.) to generate the output data 140. The output data 140 can indicate the class label 148 based on the processed values 302. The class label 148 can indicate a degree to which the client device 110 is vulnerable to a malware attack. For example, the class label 148 can indicate a “high-risk” machine if the processed values 302 indicate that the client device 110 has multiple attributes that make it vulnerable to a malware attack. Alternatively, the class label 148 can indicate a “low-risk” machine if the processed values 302 indicate that the client device 110 has a relatively low number of attributes that make it vulnerable to a malware attack.

The risk score 142 can be generated based on the output data 140. For example, the risk score 142 can increase based on one or more of the values 302 having the first value indicative of an attribute having a vulnerability. Additionally, the risk score 142 can decrease based on one or more of the values 302 having the second value indicative of an attribute not having a vulnerability.

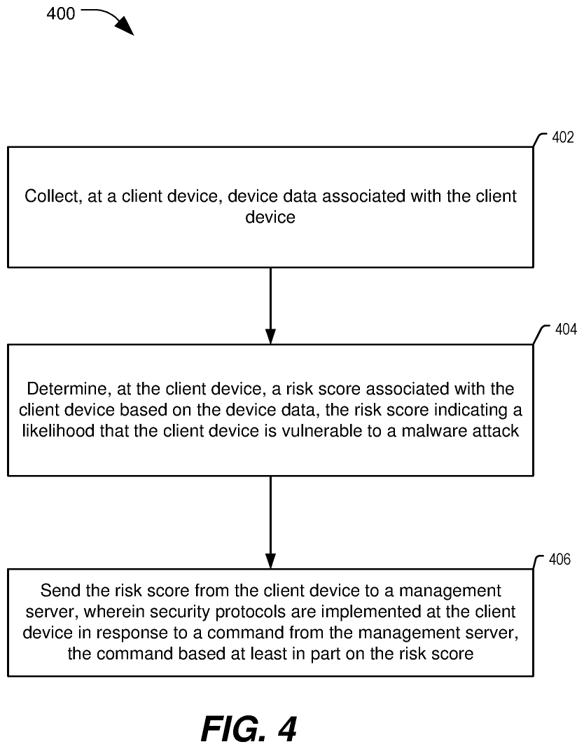

Referring to FIG. 4, a method of determining a likelihood that a client device is vulnerable to a malware attack is shown and generally designated 400. In a particular aspect, one or more of the operations of the method 400 are performed by the one or more processors 114, the transceiver 116, the client device 110, the system 100, or a combination thereof.

The method 400 includes collecting, at a client device, device data associated with the client device, at block 402. For example, referring to FIG. 1, the data collector 120 collects the device data 130 associated with the client device 110. As illustrated in FIG. 2, the collection of the device data 130 can include fetching the device data 130 from the storage device 202.

The method 400 also includes determining, at the client device, a risk score associated with the client device based on the device data, at block 404. The risk score indicates a likelihood that the client device is vulnerable to a malware attack. For example, referring to FIG. 1, the risk score generator 122 determines the risk score 142 associated with the client device 110 based on the device data 130. To determine the risk score 142, the one or more processors 114 provide the device data 130 as an input to the machine-learning model 138. The machine-learning model 138 generates the output data 140 based on the device data 130.

The method 400 also includes sending the risk score from the client device to a management server, at block 406. Security protocols are implemented at the client device in response to a command from the management server. The command is based at least in part on the risk score. For example, referring to FIG. 1, the transceiver 116 sends the data packet 180 from the client device 110 to the management server 150. The data packet 180 includes the output data 140 and the risk score 142. In response to receiving the data packet 180, the management server 150 determines security protocols 144 to be implemented at the client device 110 based on the risk score 142.

The method 400 of FIG. 4 improves processing efficiency at the management server 150 by reducing the amount of data the management server 150 has to filter through to determine whether the client device 110 is at risk for malware. For example, instead of sending an expansive amount of data (e.g., the device data 130) to the management server 150, the client device 110 can perform a client-side determination of the risk score 142 and send data indicative of the risk score 142 (e.g., the output data 140 and the risk score 142) to the management server 150. Thus, the management server 150 receives a relatively small amount of data to process and can determine the appropriate security protocols 144 based on the small amount of data.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module or a decision model may take the form of a processing apparatus executing code, an internet based (e.g., cloud computing) embodiment, an entirely hardware embodiment, or an embodiment combining aspects of the internet, software and hardware. Furthermore, the system may take the form of a computer program product on a computer-readable medium or device having computer-readable program code (e.g., instructions) embodied or stored in the storage medium or device. Any suitable computer-readable medium or device may be utilized, including hard disks, CD-ROM, optical storage devices, magnetic storage devices, and/or other storage media. As used herein, a “computer-readable medium” or “computer-readable device” is not a signal.

Systems and methods may be described herein with reference to screen shots, block diagrams and flowchart illustrations of methods, apparatuses (e.g., systems), and computer media according to various aspects. It will be understood that each functional block of a block diagram and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In conjunction with the described devices and techniques, an apparatus includes means for collecting device data associated with a client device. For example, the means for collecting may include the one or more processors 114, the data collector 120, the system 100 of FIG. 1, one or more components configured to collect device data associated with the client device, or any combination thereof.

The apparatus also includes means for determining a risk score associated with the client device based on the device data. The risk score indicates a likelihood that the client device is vulnerable to a malware attack. For example, the means for determining the risk score may include the one or more processors 114, the risk score generator 122, the machine-learning model 138, the system 100 of FIG. 1, one or more components configured to determine the risk score associated with the client device based on the device data, or any combination thereof.

The apparatus also includes means for sending the risk score from the client device to a management server. Security protocols are implemented at the client device in response to a command from the management server, and the command is based at least in part on the risk score. For example, the means for sending the risk score may include the one or more processors 114, the transceiver 116, a transmitter, the system 100 of FIG. 1, one or more components configured to send the risk score from the client device to the management server, or any combination thereof.

Particular aspects of the disclosure are described below in the following examples:

### EXAMPLE 1

A device includes: one or more processors, the one or more processors configured to: collect, at a client device, device data associated with the client device; determine, at the client device, a risk score associated with the client device based on the device data, the risk score indicating a likelihood that the client device is vulnerable to a malware attack; and send the risk score from the client device to a management server, wherein security protocols are implemented at the client device in response to a command from the management server, the command based at least in part on the risk score.

### EXAMPLE 2

The device of Example 1, wherein the device data indicates at least one of a type of software installed at the client device, a version of software installed at the client device, a developer of software installed at the client device, a process executed at the client device, an internet protocol (IP) address accessed at the client device, user activity at the client device, or a security setting implemented at the client device.

### EXAMPLE 3

The device of any of Examples 1 to 2, wherein, to determine the risk score, the one or more processors are configured to: provide the device data as an input to a machine-learning model, the machine-learning model configured to generate output data based on the device data, wherein the output data indicates a class label for one or more attributes of the device data; and generate the risk score based on the output data.

### EXAMPLE 4

The device of any of Examples 1 to 3, wherein the one or more processors are further configured to send the output data to the management server with the risk score.

### EXAMPLE 5

The device of any of Examples 1 to 4, wherein, based on the device data, the machine-learning model is configured to: determine whether a particular type of software installed at the client device has a known vulnerability; and generate a particular portion of the output data indicating whether the particular type of software has a known vulnerability, wherein the risk score increases in response to the particular portion of the output data having a first value indicating the particular type of software has a known vulnerability, and wherein the risk score decreases in response to the particular portion of the output data having a second value indicating the particular type of software does not have a known vulnerability.

### EXAMPLE 6

The device of any of Examples 1 to 5, wherein, based on the device data, the machine-learning model is configured to: determine whether a version of particular software installed at the client device is a latest version of the particular software; and generate a particular portion of the output data indicating whether the version of the particular software is the latest version of the particular software, wherein the risk score increases in response to the particular portion of the output data having a first value indicating the version of the particular software is not the latest version of the particular software, and wherein the risk score decreases in response to the particular portion of the output data having a second value indicating the version of the particular software is the latest version of the particular software.

### EXAMPLE 7

The device of any of Examples 1 to 6, wherein, based on the device data, the machine-learning model is configured to: determine whether a developer of particular software installed at the client device has developed other software with known vulnerabilities; and generate a particular portion of the output data indicating whether the developer of the particular software has developed other software with known vulnerabilities, wherein the risk score increases in response to the particular portion of the output data having a first value indicating the developer of the particular software has developed other software with known vulnerabilities, and wherein the risk score decreases in response to the particular portion of the output data having a second value indicating the developer of the particular software has not developed other software with known vulnerabilities.

### EXAMPLE 8

The device of any of Examples 1 to 7, wherein, based on the device data, the machine-learning model is configured to: determine whether a particular process executed at the client device has a known vulnerability; and generate a particular portion of the output data indicating whether the particular process has a known vulnerability, wherein the risk score increases in response to the particular portion of the output data having a first value indicating the particular process has a known vulnerability, and wherein the risk score decreases in response to the particular portion of the output data having a second value indicating the particular process does not have a known vulnerability.

### EXAMPLE 9

The device of any of Examples 1 to 8, wherein, based on the device data, the machine-learning model is configured to: determine whether an internet protocol (IP) address accessed at the client device is historically associated with malware; and generate a particular portion of the output data indicating whether the IP address is historically associated with malware, wherein the risk score increases in response to the particular portion of the output data having a first value indicating the IP address is historically associated with malware, and wherein the risk score decreases in response to the particular portion of the output data having a second value indicating the IP address is not historically associated with malware.

### EXAMPLE 10

The device of any of Examples 1 to 9, wherein, based on the device data, the machine-learning model is configured to: determine whether a security setting implemented at the client device is a recommended security setting; and generate a particular portion of the output data indicating whether the security setting is the recommended security setting, wherein the risk score increases in response to the particular portion of the output data having a first value indicating the security setting is not the recommended security setting, and wherein the risk score decreases in response to the particular portion of the output data having a second value indicating the security setting is the recommended security setting.

### EXAMPLE 11

The device of any of Examples 1 to 10, wherein the security protocols comprise changing a security setting that is implemented at the client device.

### EXAMPLE 12

The device of any of Examples 1 to 11, wherein the security protocols comprise isolating the client device from a shared network.

### EXAMPLE 13

The device of any of Examples 1 to 12, wherein the command is further based on a classification of the client device.

### EXAMPLE 14

The device of any of Examples 1 to 13, wherein the classification of the client device corresponds to at least one of a governmental agency device, a military department device, a banking system device, a school system device, a business device, or a personal device.

### EXAMPLE 15

A method includes: collecting, at a client device, device data associated with the client device; determining, at the client device, a risk score associated with the client device based on the device data, the risk score indicating a likelihood that the client device is vulnerable to a malware attack; and sending the risk score from the client device to a management server, wherein security protocols are implemented at the client device in response to a command from the management server, the command based at least in part on the risk score.

### EXAMPLE 16

The method of Example 15, wherein the device data indicates at least one of a type of software installed at the client device, a version of software installed at the client device, a developer of software installed at the client device, a process executed at the client device, an internet protocol (IP) address accessed at the client device, user activity at the client device, or a security setting implemented at the client device.

### EXAMPLE 17

The method of any of Examples 15 to 16, wherein determining the risk score comprises: providing the device data as an input to a machine-learning model, the machine-learning model configured to generate output data based on the device data, wherein the output data indicates a class label for one or more attributes of the device data; and generating the risk score based on the output data.

### EXAMPLE 18

The method of any of Examples 15 to 17, further comprising sending the output data to the management server with the risk score.

### EXAMPLE 19

The method of any of Examples 15 to 18, wherein, based on the device data, the machine-learning model is configured to: determine whether a particular type of software installed at the client device has a known vulnerability; and generate a particular portion of the output data indicating whether the particular type of software has a known vulnerability, wherein the risk score increases in response to the particular portion of the output data having a first value indicating the particular type of software has a known vulnerability, and wherein the risk score decreases in response to the particular portion of the output data having a second value indicating the particular type of software does not have a known vulnerability.

### EXAMPLE 20

The method of any of Examples 15 to 19, wherein, based on the device data, the machine-learning model is configured to: determine whether a version of particular software installed at the client device is a latest version of the particular software; and generate a particular portion of the output data indicating whether the version of the particular software is the latest version of the particular software, wherein the risk score increases in response to the particular portion of the output data having a first value indicating the version of the particular software is not the latest version of the particular software, and wherein the risk score decreases in response to the particular portion of the output data having a second value indicating the version of the particular software is the latest version of the particular software.

### EXAMPLE 21

The method of any of Examples 15 to 20, wherein, based on the device data, the machine-learning model is configured to: determine whether a developer of particular software installed at the client device has developed other software with known vulnerabilities; and generate a particular portion of the output data indicating whether the developer of the particular software has developed other software with known vulnerabilities, wherein the risk score increases in response to the particular portion of the output data having a first value indicating the developer of the particular software has developed other software with known vulnerabilities, and wherein the risk score decreases in response to the particular portion of the output data having a second value indicating the developer of the particular software has not developed other software with known vulnerabilities.

### EXAMPLE 22

The method of any of Examples 15 to 21, wherein, based on the device data, the machine-learning model is configured to: determine whether a particular process executed at the client device has a known vulnerability; and generate a particular portion of the output data indicating whether the particular process has a known vulnerability, wherein the risk score increases in response to the particular portion of the output data having a first value indicating the particular process has a known vulnerability, and wherein the risk score decreases in response to the particular portion of the output data having a second value indicating the particular process does not have a known vulnerability.

### EXAMPLE 23

The method of any of Examples 15 to 22, wherein, based on the device data, the machine-learning model is configured to: determine whether an internet protocol (IP) address accessed at the client device is historically associated with malware; and generate a particular portion of the output data indicating whether the IP address is historically associated with malware, wherein the risk score increases in response to the particular portion of the output data having a first value indicating the IP address is historically associated with malware, and wherein the risk score decreases in response to the particular portion of the output data having a second value indicating the IP address is not historically associated with malware.

### EXAMPLE 24

The method of any of Examples 15 to 23, wherein, based on the device data, the machine-learning model is configured to: determine whether a security setting implemented at the client device is a recommended security setting; and generate a particular portion of the output data indicating whether the security setting is the recommended security setting, wherein the risk score increases in response to the particular portion of the output data having a first value indicating the security setting is not the recommended security setting, and wherein the risk score decreases in response to the particular portion of the output data having a second value indicating the security setting is the recommended security setting.

### EXAMPLE 25

The method of any of Examples 15 to 24, wherein the security protocols comprise changing a security setting that is implemented at the client device.

### EXAMPLE 26

The method of any of Examples 15 to 25, wherein the security protocols comprise isolating the client device from a shared network.

### EXAMPLE 27

The method of any of Examples 15 to 26, wherein the command is further based on a classification of the client device.

### EXAMPLE 28

The method of any of Examples 15 to 27, wherein the classification of the client device corresponds to at least one of a governmental agency device, a military department device, a banking system device, a school system device, a business device, or a personal device.

### EXAMPLE 29

A non-transitory computer-readable medium stores instructions that, when executed by one or more processors, cause the one or more processors to: collect, at a client device, device data associated with the client device; determine, at the client device, a risk score associated with the client device based on the device data, the risk score indicating a likelihood that the client device is vulnerable to a malware attack; and send the risk score from the client device to a management server, wherein security protocols are implemented at the client device in response to a command from the management server, the command based at least in part on the risk score.

### EXAMPLE 30

The non-transitory computer-readable medium of Example 29, wherein the device data indicates at least one of a type of software installed at the client device, a version of software installed at the client device, a developer of software installed at the client device, a process executed at the client device, an internet protocol (IP) address accessed at the client device, user activity at the client device, or a security setting implemented at the client device.

### EXAMPLE 31

The non-transitory computer-readable medium of any of Examples 29 to 30, wherein, to determine the risk score, the instructions, when executed by the one or more processors, cause the one or more processors to: provide the device data as an input to a machine-learning model, the machine-learning model configured to generate output data based on the device data, wherein the output data indicates a class label for one or more attributes of the device data; and generate the risk score based on the output data.

### EXAMPLE 32

The non-transitory computer-readable medium of any of Examples 29 to 31, wherein the one or more processors are further configured to send the output data to the management server with the risk score.

### EXAMPLE 33

The non-transitory computer-readable medium of any of Examples 29 to 32, wherein, based on the device data, the machine-learning model is configured to: determine whether a particular type of software installed at the client device has a known vulnerability; and generate a particular portion of the output data indicating whether the particular type of software has a known vulnerability, wherein the risk score increases in response to the particular portion of the output data having a first value indicating the particular type of software has a known vulnerability, and wherein the risk score decreases in response to the particular portion of the output data having a second value indicating the particular type of software does not have a known vulnerability.

### EXAMPLE 34

The non-transitory computer-readable medium of any of Examples 29 to 33, wherein, based on the device data, the machine-learning model is configured to: determine whether a version of particular software installed at the client device is a latest version of the particular software; and generate a particular portion of the output data indicating whether the version of the particular software is the latest version of the particular software, wherein the risk score increases in response to the particular portion of the output data having a first value indicating the version of the particular software is not the latest version of the particular software, and wherein the risk score decreases in response to the particular portion of the output data having a second value indicating the version of the particular software is the latest version of the particular software.

### EXAMPLE 35

The non-transitory computer-readable medium of any of Examples 29 to 34, wherein, based on the device data, the machine-learning model is configured to: determine whether a developer of particular software installed at the client device has developed other software with known vulnerabilities; and generate a particular portion of the output data indicating whether the developer of the particular software has developed other software with known vulnerabilities, wherein the risk score increases in response to the particular portion of the output data having a first value indicating the developer of the particular software has developed other software with known vulnerabilities, and wherein the risk score decreases in response to the particular portion of the output data having a second value indicating the developer of the particular software has not developed other software with known vulnerabilities.

### EXAMPLE 36

The non-transitory computer-readable medium of any of Examples 29 to 35, wherein, based on the device data, the machine-learning model is configured to: determine whether a particular process executed at the client device has a known vulnerability; and generate a particular portion of the output data indicating whether the particular process has a known vulnerability, wherein the risk score increases in response to the particular portion of the output data having a first value indicating the particular process has a known vulnerability, and wherein the risk score decreases in response to the particular portion of the output data having a second value indicating the particular process does not have a known vulnerability.

### EXAMPLE 37

The non-transitory computer-readable medium of any of Examples 29 to 36, wherein, based on the device data, the machine-learning model is configured to: determine whether an internet protocol (IP) address accessed at the client device is historically associated with malware; and generate a particular portion of the output data indicating whether the IP address is historically associated with malware, wherein the risk score increases in response to the particular portion of the output data having a first value indicating the IP address is historically associated with malware, and wherein the risk score decreases in response to the particular portion of the output data having a second value indicating the IP address is not historically associated with malware.

### EXAMPLE 38

The non-transitory computer-readable medium of any of Examples 29 to 37, wherein, based on the device data, the machine-learning model is configured to: determine whether a security setting implemented at the client device is a recommended security setting; and generate a particular portion of the output data indicating whether the security setting is the recommended security setting, wherein the risk score increases in response to the particular portion of the output data having a first value indicating the security setting is not the recommended security setting, and wherein the risk score decreases in response to the particular portion of the output data having a second value indicating the security setting is the recommended security setting.

### EXAMPLE 39

The non-transitory computer-readable medium of any of Examples 29 to 38, wherein the security protocols comprise changing a security setting that is implemented at the client device.

### EXAMPLE 40

The non-transitory computer-readable medium of any of Examples 29 to 39, wherein the security protocols comprise isolating the client device from a shared network.

### EXAMPLE 41

The non-transitory computer-readable medium of any of Examples 29 to 40, wherein the command is further based on a classification of the client device.

### EXAMPLE 42

The non-transitory computer-readable medium of any of Examples 29 to 41, wherein the classification of the client device corresponds to at least one of a governmental agency device, a military department device, a banking system device, a school system device, a business device, or a personal device.

Although the disclosure may include one or more methods, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non- exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A device comprising:
one or more processors, the one or more processors configured to:
collect, at a client device, device data associated with the client device;
determine, at the client device, a risk score associated with the client device based on the device data, the risk score indicating a likelihood that the client device is vulnerable to a malware attack; and
send the risk score from the client device to a management server, wherein security protocols are implemented at the client device in response to a command from the management server, the command based at least in part on the risk score.

2. The device of claim 1, wherein the device data indicates at least one of a type of software installed at the client device, a version of software installed at the client device, a developer of software installed at the client device, a process executed at the client device, an internet protocol (IP) address accessed at the client device, user activity at the client device, or a security setting implemented at the client device.

3. The device of claim 1, wherein, to determine the risk score, the one or more processors are configured to:
provide the device data as an input to a machine-learning model, the machine- learning model configured to generate output data based on the device data, wherein the output data indicates a class label for one or more attributes of the device data; and
generate the risk score based on the output data.

4. The device of claim 3, wherein the one or more processors are further configured to send the output data to the management server with the risk score.

5. The device of claim 3, wherein, based on the device data, the machine-learning model is configured to:
determine whether a particular type of software installed at the client device has a known vulnerability; and
generate a particular portion of the output data indicating whether the particular type of software has a known vulnerability,
wherein the risk score increases in response to the particular portion of the output data having a first value indicating the particular type of software has a known vulnerability, and wherein the risk score decreases in response to the particular portion of the output data having a second value indicating the particular type of software does not have a known vulnerability.

6. The device of claim 3, wherein, based on the device data, the machine-learning model is configured to:
determine whether a version of particular software installed at the client device is a latest version of the particular software; and
generate a particular portion of the output data indicating whether the version of the particular software is the latest version of the particular software,
wherein the risk score increases in response to the particular portion of the output data having a first value indicating the version of the particular software is not the latest version of the particular software, and wherein the risk score decreases in response to the particular portion of the output data having a second value indicating the version of the particular software is the latest version of the particular software.

7. The device of claim 3, wherein, based on the device data, the machine-learning model is configured to:
determine whether a developer of particular software installed at the client device has developed other software with known vulnerabilities; and
generate a particular portion of the output data indicating whether the developer of the particular software has developed other software with known vulnerabilities,
wherein the risk score increases in response to the particular portion of the output data having a first value indicating the developer of the particular software has developed other software with known vulnerabilities, and wherein the risk score decreases in response to the particular portion of the output data having a second value indicating the developer of the particular software has not developed other software with known vulnerabilities.

8. The device of claim 3, wherein, based on the device data, the machine- learning model is configured to:
determine whether a particular process executed at the client device has a known vulnerability; and
generate a particular portion of the output data indicating whether the particular process has a known vulnerability,
wherein the risk score increases in response to the particular portion of the output data having a first value indicating the particular process has a known vulnerability, and wherein the risk score decreases in response to the particular portion of the output data having a second value indicating the particular process does not have a known vulnerability.

9. The device of claim 3, wherein, based on the device data, the machine-learning model is configured to:
determine whether an internet protocol (IP) address accessed at the client device is historically associated with malware; and
generate a particular portion of the output data indicating whether the IP address is historically associated with malware,
wherein the risk score increases in response to the particular portion of the output data having a first value indicating the IP address is historically associated with malware, and wherein the risk score decreases in response to the particular portion of the output data having a second value indicating the IP address is not historically associated with malware.

10. The device of claim 3, wherein, based on the device data, the machine-learning model is configured to:
determine whether a security setting implemented at the client device is a recommended security setting; and
generate a particular portion of the output data indicating whether the security setting is the recommended security setting,
wherein the risk score increases in response to the particular portion of the output data having a first value indicating the security setting is not the recommended security setting, and wherein the risk score decreases in response to the particular portion of the output data having a second value indicating the security setting is the recommended security setting.

11. The device of claim 1, wherein the security protocols comprise changing a security setting that is implemented at the client device.

12. The device of claim 1, wherein the security protocols comprise isolating the client device from a shared network.

13. The device of claim 1, wherein the command is further based on a classification of the client device.

14. The device of claim 13, wherein the classification of the client device corresponds to at least one of a governmental agency device, a military department device, a banking system device, a school system device, a business device, or a personal device.

15. A method comprising:
collecting, at a client device, device data associated with the client device;
determining, at the client device, a risk score associated with the client device based on the device data, the risk score indicating a likelihood that the client device is vulnerable to a malware attack; and
sending the risk score from the client device to a management server, wherein security protocols are implemented at the client device in response to a command from the management server, the command based at least in part on the risk score.

16. The method of claim 15, wherein the device data indicates at least one of a type of software installed at the client device, a version of software installed at the client device, a developer of software installed at the client device, a process executed at the client device, an internet protocol (IP) address accessed at the client device, user activity at the client device, or a security setting implemented at the client device.

17. The method of claim 15,
wherein determining the risk score comprises:
providing the device data as an input to a machine-learning model, the machine-learning model configured to generate output data based on the device data, wherein the output data indicates a class label for one or more attributes of the device data; and
generating the risk score based on the output data; and
further comprising sending the output data to the management server with the risk score.

18. A non-transitory computer-readable medium storing instructions that, when executed by one or more processors, cause the one or more processors to:
collect, at a client device, device data associated with the client device;
determine, at the client device, a risk score associated with the client device based on the device data, the risk score indicating a likelihood that the client device is vulnerable to a malware attack; and
send the risk score from the client device to a management server, wherein security protocols are implemented at the client device in response to a command from the management server, the command based at least in part on the risk score.

19. The non-transitory computer-readable medium of claim 18, wherein the device data indicates at least one of a type of software installed at the client device, a version of software installed at the client device, a developer of software installed at the client device, a process executed at the client device, an internet protocol (IP) address accessed at the client device, user activity at the client device, or a security setting implemented at the client device.

20. The non-transitory computer-readable medium of claim 18, wherein the command indicating the security protocols to be implemented at the client device is further based on a classification of the client device.
